(19) United States
(12) Patent Application Publication
(10) Pub. No.: US 2010/0221484 A1
(43) Pub. Date: Sep. 2, 2010

(54) CERAMIC SEALED TRANSMISSIVE SUBSTRATE ASSEMBLIES

(75) Inventor: Anthony MEADE, Wenatchee, WA (US)

Correspondence Address: SPECKMAN LAW GROUP PLLC, 1201 THIRD AVENUE, SUITE 330, SEATTLE, WA, 98101, US

(73) Assignee: PACIFIC AEROSPACE & ELECTRONICS, INC., Wenatchee, WA (US)

(21) Appl. No.: 12/709,410

(22) Filed: Feb. 19, 2010

Related U.S. Application Data
(60) Provisional application No. 61/156,403, filed on Feb. 27, 2009.

(51) Int. Cl. B32B 3/02; B32B 37/00; B32B 38/00

(52) U.S. Cl. 428/66.7; 156/293; 156/89.11; 156/280

(57) ABSTRACT

EMR-transmissive window assemblies comprising an EMR-transmissive substrate mounted in a substantially rigid framework structure and sealed to the metallic framework structure by means of a ceramic material having a partially amorphous and partially crystalline structure are disclosed. Methods for fabricating EMR-transmissive assemblies are also disclosed.

### REFERENCE TO RELATED APPLICATIONS

This application claims priority to U.S. Provisional Patent Application No. 61/156,403 filed Feb. 27, 2009.

### TECHNICAL FIELD OF THE INVENTION

The present invention relates to assemblies having an electromagnetic radiation (EMR)-transmissive substrate, such as a window, lens, port, or another EMR-transmissive substrate, sealed to a metallic enclosure such as a framework structure to form a transmissive assembly that may be installed in an electronics package, an optical module, a signal transmitter/receiver, or the like. In specific embodiments, the present invention relates to assemblies incorporating a window having optical, infrared, ultra-violet, radio frequency, microwave or other EMR-transmissive properties and using ceramic materials to directly seal and, in some embodiments, to directly and hermetically seal the EMR-transmissive substrate to a metallic framework structure that may be bonded or sealed in a larger structure to provide a sealed enclosure, often a hermetically sealed enclosure. Methods for sealing EMR-transmissive substrates in metallic structures are also disclosed.

### BACKGROUND OF THE INVENTION

EMR-transmissive windows are used in various applications, such as electronics packages, including microwave electronics packages, optical module packages, space and defense-related electronics packages, medical devices employing lasers or requiring transmission of light or radiation, and the like. The housings for these types of devices and components are typically constructed from metallic materials, which have thermal properties that are very different from glass and other EMR-transmissive materials. In most applications, the window is first mounted in a window framework structure, and the window framework structure is then mounted in a recess or port in a housing or in a larger electronics package, component or assembly. The framework, housing, packages, and the like are typically metallic because metallic materials offer favorable temperature properties, conductivity, durability and weight, and they can be shaped or machined to required configurations, dimensions and tolerances. Reliable sealing of the window to its framework structure, and reliable sealing of the window framework structure to the package or larger assembly, is critical because the components, packages and the like are often subjected to temperature cycling and temperature variations during operation. These components and assemblies may also be used in harsh environments in which high reliability seals that separate the interior from the exterior environment are essential to component function, and may be essential to mission function.

Waveguide windows are typically mounted in electronics packages using bonding materials (e.g. epoxy), soldering or brazing techniques. The type of glass used, and the life of the device, are generally limited by the ability to reliably bond the window to framework structures fabricated from commercially available metals, and the ability to bond the metallic framework to the surrounding package or housing. Soldering and brazing typically require multiple steps including metallization, plating, multiple heating steps, modified atmosphere environments and, in general, specialized conditions. (See, e.g., U.S. Pat. No. 6,123,464.) Active brazing techniques can provide reliable seals but are time consuming and require multiple processing steps under different processing conditions; active brazing techniques are consequently relatively expensive.

Techniques have been developed for sealing metallic framework structures to larger packages, electronics components, and the like. A glass window may be sealed to a metal framework composed of an iron-containing metal such as Kovar®, for example, using a conventional glass-to-metal sealing technique involving metallization and brazing or soldering. The Kovar® framework is then mounted in an electronics package composed, for example, of Aluminum, using an intermediate structure, such as a copper bellows, a transition bushing composed of dissimilar materials, or the like.

U.S. Pat. No. 5,986,208 discloses numerous systems for mounting transmissive windows in electronics packages. U.S. Pat. No. 7,365,620 discloses a microwave window structure employing a metallic frame having a two-metal structure that facilitates soldering of the window to one part of the metallic frame and sealing the other part of the metallic frame in a package or another structure. Another proposed solution for providing a reliable seal between glass and a metallic framework is to use metal injection molding (MIM) technology to tailor the thermal expansion properties of the metal frame to match the coefficient of expansion of the desired glass.

Notwithstanding these attempts to provide reliable glass to metal seals and reliable seals between a framework structure and the larger housing or package, component failure in the region of the glass to metal seals is an all too frequent an occurrence.

### SUMMARY

Assemblies of the present invention use a ceramic material having a partially amorphous and partially crystalline structure to seal an EMR-transmissive substrate, such as a non-metallic window, a lens, a port, or the like, in a rigid (e.g., metallic or non-metallic) frame and/or housing, thereby providing a reliable bond and, in some embodiments, a hermetic seal, without soldering, brazing, or using specialized glass or metallic materials, and without requiring metallization, plating or the like. Suitable ceramic materials having a partially amorphous and partially crystalline structure are available and are capable of sealing various EMR-transmissive materials, such as sapphire, quartz, germanium, borosilicate glass, and the like, as well as other types of optically transmissive substrates, laser transmissive substrates, infrared transmissive substrates, ultra-violet transmissive substrates, radio frequency transmissive substrates and microwave transmissive substrates, directly to substantially rigid framework structures under generally low temperature conditions that don't require specialized pressure or atmospheric conditions. The seals produced are highly reliable even when components are used in harsh environments, and when significant thermal cycling or thermal disparities are experienced during operation. EMR-transmissive substrates sealed in framework or housing structures using ceramic materials disclosed herein are capable of maintaining hermeticity following repeated sterilization and autoclaving cycles, and they are thus suitable for use in medical devices incorporating EMR-transmissive substrates, as well as in optical and transmitter/receiver components and assemblies for use in space, defense-related LADAR, laser designation/acquisition systems, implantable and other types of medical devices, surgical and minimally invasive surgical instruments, and the like.

Suitable ceramic sealing materials are described, for example, in U.S. Pat. Nos. 4,401,766, 4,461,926 and 4,593,758. Kryoflex® is a suitable ceramic sealing material and is manufactured and used by Pacific Aerospace and Electronics, Inc., Wenatchee Wash. Although these types of ceramic sealing materials have been used to provide hermetic seals between spaced metallic members, such as terminal pins and ferrules, and other metallic components, such ceramic sealing materials have not been used, to applicant's knowledge, to seal non-metallic, EMR-transmissive structures in metallic or non-metallic framework or packaging structures. The inventor herein discovered, unexpectedly, that the use of these known ceramic materials to seal non-metallic, EMR-transmissive substrates to metallic or non-metallic framework structures produced reliable, hermetically sealed assemblies. In fact, hermetically sealed assemblies comprising an EMR-transmissive substrate sealed in a metallic framework structure were constructed and demonstrated reliable hermeticity, with assemblies having a leak rate less than or equal to 1×10⁻⁷ cc/sec Helium at 1 atmospheric pressure differential.

### BRIEF DESCRIPTION OF THE DRAWINGS

FIG. 1 shows a top view of a window assembly of the present invention comprising an transmissive lens mounted in a framework structure; and

FIG. 2 shows a cross-sectional view of the window assembly, taken through line 2-2 of the assembly illustrated in FIG. 1, and shows ceramic pre-forms positioned in a bonding region in an uncured state;

FIG. 3 shows the window assembly of FIG. 2 following curing, or fusing, of the ceramic material to provide a ceramic seal between the transmissive lens and the framework structure.

### DESCRIPTION OF THE INVENTION

Suitable EMR-transmissive materials for use in transmissive assemblies of the present invention include EMR-transmissive materials such as, but not limited to, quartz, sapphire, aluminum oxide, germanium, borosilicate glass, and the like. Metallic framework structures are typically fabricated from Aluminum and Aluminum-containing alloys, Titanium and Titanium-containing materials, Stainless Steels and other iron- and nickel-containing materials and alloys, and similar metallic materials. The metallic framework structure is generally sealable in a wide range of metals, including Aluminum and Aluminum-containing alloys, Titanium and Titanium-containing materials, Stainless Steels and other iron- and nickel-containing materials and alloys, and similar metallic materials. Sealing techniques that provide a low heat affected zone (low HAZ), such as laser welding, are generally preferred and may be used to provide reliable, hermetic seals between the metallic components without damaging other nearby components, such as windows, window-to-framework seals, and the like. Transition bushings, direct sealing into explosively bonded materials, as well as other similar types of intermediate structures may be used, as appropriate, to join dissimilar metallic components, as is known in the art. Non-metallic framework structures suitable for use in assemblies of the present invention are typically fabricated from cermet or ceramic materials or composite materials, including metal matrix composite materials.

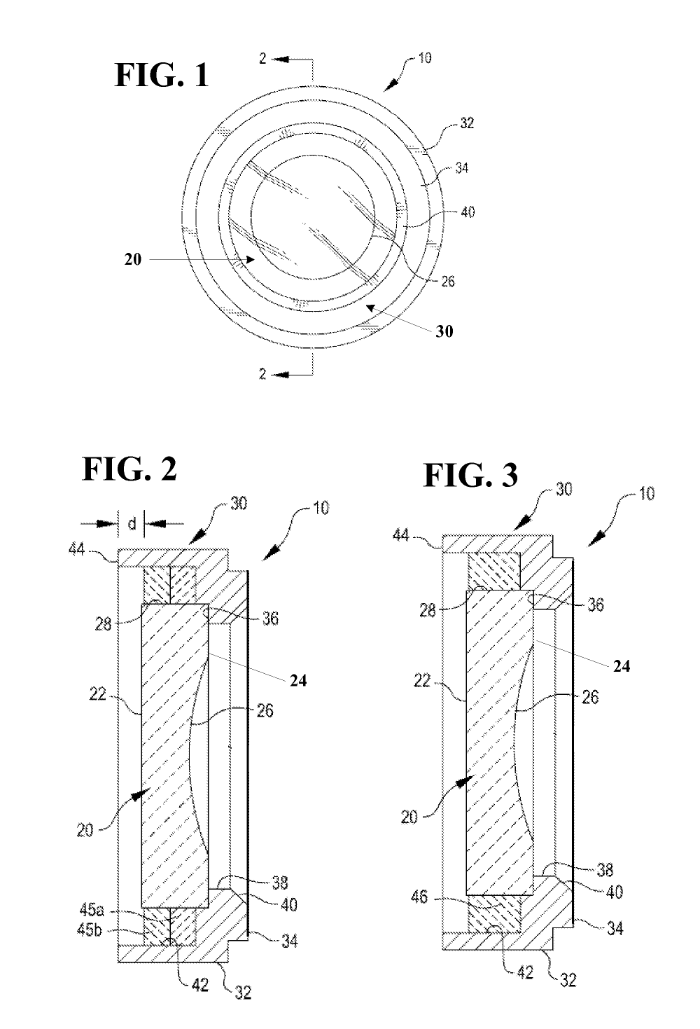

FIG. 1 illustrates a top view and FIGS. 2 and 3 illustrate cross-sectional views of illustrative lens/window assemblies 10 of the present invention. It will be appreciated that this embodiment is being shown and described for illustrative purposes only and that many other embodiments are contemplated and would be evident to one of ordinary skill in the art. In the specific embodiment illustrated in FIGS. 1 and 2, EMR-transmissive lens 20 is mounted in framework structure 30 and sealed using ceramic preforms 45a, 45b that, during and following appropriate heat treatment, provide a seal 46 between window 20 and framework structure 30. Lens/window components may be mounted and sealed in framework structures using methods of the present invention to provide sealed (and, optionally, hermetically sealed) EMR-transmissive substrate assemblies in the absence of metallization, plating, soldering, brazing and/or welding processes.

Lens 20, as illustrated, comprises a substantially solid, substantially EMR-transmissive material. EMR-transmissive substrates suitable for use in assemblies of the present invention, illustrated here in the form of lens 20, may have a variety of peripheral configurations (e.g., round, oval, rectangular, polygonal, etc.), and may have flat and/or curved faces. Curved face(s) may be either convex or concave, or may have a more complex curved configuration or comprise multiple convex and/or concave surfaces. In the embodiment illustrated in FIG. 1, lens 20 has one substantially planar face 22, an opposite face having a planar surface 24 at the periphery and a central curved surface 26. A substantially flat peripheral wall or peripheral edge 28 is provided at generally right angles to the planar peripheral surfaces of the window faces. In alternative embodiments, peripheral edge 28 may be tapered, or partially tapered, either toward or away from the center of the lens. Window 22 is preferably EMR-transmissive and may comprise, but is not limited to comprising, sapphire, such as optical grade single-crystal sapphire, quartz, germanium, borosilicate glass, and the like.

In some embodiments, framework structure 30 is composed of a rigid metallic material, such as Aluminum or an Aluminum-containing metal or alloy, Titanium or a Titanium-containing metal or alloy, stainless steels, iron-containing metals and alloys such as Kovar®, and the like. In some embodiments, framework structure 30 comprises a non-metallic material and may be comprise a cermet material, a ceramic material, a composite material (including a metal matrix composite material), and the like. Framework structure 30 may take a variety of forms, depending on the package or assembly into which it's mounted and the structure and configuration of the transmissive substrate (e.g., window, lens, port, or the like), and the framework structure may be tailored to the application and operating environment of the final assembly. In the embodiment illustrated, framework structure 30 has an exterior peripheral wall 32 and an end rim 34 having a substantially similar configuration as the configuration of window 20 and, when the assembly is assembled, end rim 34 is elevated relative to, or spaced apart from, the surface of window 20. An internal flange or shoulder 36 provides an interface and stop surface for the window and generally matches the size and configuration of the peripheral face and edge of window 20. Internal shoulder 36 is generally spaced a distance from end rim 34 because window 20 is generally recessed from the exterior surface of the framework structure. A standoff surface 38 and chamfered surface 40 may be provided between internal flange 36 and end rim 34. The configuration of the framework structure exterior to window 20 is generally designed to provide a desired transmission path for an EMR signal to travel toward, through and/or away from window 20, and to optimize EMR-transmissivity.

Framework structure 30, on other “side” of internal flange 36, cooperates with an inserted window to provide a bonding zone formed between larger diameter interior wall 42 and the side wall 28 of window 20. In the embodiment shown, internal flange/shoulder 36 is relatively shallow, both in terms of depth and width, while larger diameter interior wall 42 is both deeper and wider to provide a recess for retaining the ceramic polycrystalline sealing material, and for providing a bonding region between the sidewall of the framework structure and the sidewall of the transmissive substrate. In some embodiments, as in the illustrated structure, the bonding region formed between the sidewall of the framework structure and the sidewall of the transmissive substrate is an annular region. The depth of the bonding region is generally at least about 25% the depth dimension of side wall 28 of window 20 and, in some embodiments is at least about 40% the depth dimension of side wall 28 of window 20. In some embodiments, the depth of the bonding region is at least about 50% or 60% the depth dimension of side wall 28 of window 20. The width of the bonding region, measured as the space between framework interior wall 42 and side wall 28 of window 20, is generally at least about 15% the depth dimension of side wall 28 of window 20 and, in some embodiments is at least about 25% the depth dimension of side wall 28 of window 20. In some embodiments, the width of the bonding region is at least about 40% or 50% the depth dimension of side wall 28 of window 20.

The configuration of the bonding region formed between the internal surface of larger diameter interior wall 42 and the external peripheral edge 28 of window 20 generally matches the peripheral configuration of the window. During the sealing process, one or more ceramic sealing material(s) are deposited in this bonding region in an uncured format and the assembly is treated to cure the uncured ceramic material, converting the uncured ceramic material to its sealing form. In some embodiments, the sealing process involves placement of the uncured ceramic sealing material(s) in the bonding region followed by heat treatment to cure the ceramic sealing material(s). The ceramic sealing material preferably contacts only the external peripheral edge of the transmissive substrate and does not contact or otherwise interfere with the EMR-transmissive faces of window 20.

In the embodiments illustrated in FIGS. 2 and 3, ceramic performs 45a and 45b are sized and configured for placement in the bonding region and comprise an uncured polycrystalline ceramic material that is partially amorphous and partially crystalline. Suitable materials are described, for example, in U.S. Pat. Nos. 4,461,926, 4,593,758 and 4,401,766. These materials are typically manufactured as beads or particles that may be pressed with suitable binding agents to provide preformed geometric shapes having desired configurations that can be conveniently handled and deposited in the bonding region. For the illustrated application and embodiment, ceramic preforms 45a, 45b are generally annular, having an inner diameter that generally matches the outer diameter of the window and an outer diameter that generally matches the inner diameter of interior wall 42. While the use of ceramic performs is preferred for many embodiments, it will be appreciated that sealing materials having other shapes and configurations, such as beads, particles, powders, and the like may also be used, and may be positioned in the bonding zone prior to treatment, or curing. The untreated assembly is then treated at suitable conditions, such as at high temperature conditions, for a suitable time period, to cure, or fuse, the ceramic material, thereby providing a reliable, bond, or seal 46 between window 20 and framework structure 30, as shown in FIG. 3. In preferred embodiments, seal 46 provides a hermetic seal.

The end 44 of framework sidewall 32 opposite end rim 34 preferably extends beyond or may form a flange beyond the bonding region and extends outwardly from the ceramic seal region for a distance “d.” This exposed end generally remains untreated and its exterior surface may provide a surface or region for mounting in and sealing to a larger structure or assembly, such as an electronics package, a medical device, a signal transmissive module, or the like. Depending on the materials used for various components, high reliability and low impact sealing techniques, such as laser welding, may be used to seal the framework component to a larger structure or assembly.

The illustrated window assembly and framework structure is circular. It will be appreciated that many other configurations, such as rectangular, oval, and the like may be used. Transmissive substrates of various configurations, thicknesses, sizes, and the like may be sealed using the methods and materials disclosed herein. And, while the illustrated embodiment involves sealing of an EMR-transmissive substrate in a framework structure, it will be appreciated that a transmissive substrate may be mounted and sealed directly into a larger structure or assembly using the methods and materials disclosed herein.

Methods of fabricating EMR-transmissive assemblies and, in some embodiments, hermetically sealed EMR-transmissive assemblies, involve positioning a transmissive substrate in a mating framework structure or assembly, for example, by positioning the peripheral edge of the window on a matching internal shoulder or rim of a framework structure, and then positioning uncured ceramic sealing material in a bonding region located between the peripheral wall of the window and an internal wall of the framework structure. The assembly is then treated, such as by heating, under conditions that cause the ceramic sealing material to fuse and seal, or bond, the transmissive substrate to the framework or the assembly. The sealed transmissive assembly is cooled and post-sealing processing, such as coating one or both exposed faces of the transmissive substrate with desired coating agents, e.g. anti-reflective materials, is performed. The assembly may then be mounted in and hermetically sealed to a larger assembly or structure by sealing a surface or flange of the framework structure to a mating surface of the larger assembly.

Transmissive assemblies, or ports, are used in various applications, such as electronics packages, including microwave electronics packages, module packages, space and defense-related electronics packages, signal transmitter/receiver assemblies, laser designation and acquisition systems, medical devices employing lasers, surgical and minimally invasive surgical instruments requiring signal transmission, and the like, and transmissive assemblies of the present invention may be used in any of these applications.

I claim:

1. An assembly comprising a non-metallic EMR-transmissive substrate mounted in a framework structure and bonded to the metallic framework structure by means of a ceramic material having a partially amorphous and partially crystalline structure.

2. The assembly of claim 1, wherein the non-metallic EMR-transmissive substrate comprises a material selected from the group consisting of: sapphire, quartz, germanium and borosilicate glass.

3. The assembly of claim 1, wherein the non-metallic EMR-transmissive substrate has an EMR-transmissive property selected from the group consisting of: optically transmissive; laser transmissive; microwave transmissive; radio frequency transmissive; infrared transmissive; and ultra-violet transmissive.

4. The assembly of claim 1, wherein the framework structure comprises a metallic material selected from the group consisting of: Aluminum; an Aluminum-containing metal or alloy; Titanium; a Titanium-containing metal or alloy; stainless steels; iron-containing metals; and iron-containing alloys.

5. The assembly of claim 1, wherein the framework structure comprises a material selected from the group consisting of: ceramic materials; cermet materials; composite materials; and metal matrix composite materials.

6. The assembly of claim 1, wherein the EMR-transmissive substrate has a curved face.

7. The assembly of claim 1, wherein the bond between the non-metallic EMR-transmissive substrate and the framework structure is a hermetic bond.

8. The assembly of claim 7, wherein the EMR-transmissive substrate is hermetically sealed to the metallic framework structure and is characterized by a leak rate of less than 1×10⁻⁷ cc/sec Helium at 1 atmospheric pressure differential.

9. The assembly comprising a non-metallic EMR-transmissive substrate mounted in a framework structure and having an uncured ceramic material provided in a bonding region between a peripheral edge of the EMR-transmissive substrate and an internal surface of the framework structure.

10. The assembly of claim 9, wherein the bonding region is a substantially annular space.

11. The assembly of claim 9, wherein the bonding region extends for at least about 30% of a thickness of the EMR-transmissive substrate.

12. The assembly of claim 9, wherein the uncured ceramic material is a ceramic polycrystalline sealing material.

13. The assembly of claim 9, wherein the uncured ceramic material is provided in the form of at least one ceramic preform sized and configured for placement in the bonding region.

14. A method for fabricating an EMR-transmissive assembly, comprising: positioning an EMR-transmissive substrate in a mating framework structure to provide an EMR-transmissive assembly having a bonding region formed between a peripheral wall of the EMR-transmissive substrate and an internal wall of the framework structure; positioning uncured ceramic sealing material in the bonding region; and treating the EMR-transmissive assembly under conditions that cause the ceramic sealing material to fuse and seal.

15. The method of claim 14, wherein treating involves heating the assembly under conditions that cause the ceramic sealing material to fuse and seal.

16. The method of claim 14, additionally comprising coating an exposed face of the EMR-transmissive substrate with a coating agent following treatment to fuse the ceramic sealing material.

17. The method of claim 14, wherein positioning uncured ceramic sealing material in the bonding region involves placing at least one ceramic perform comprising an uncured polycrystalline ceramic material in the bonding region.

18. The method of claim 14, wherein the uncured ceramic sealing material comprises a polycrystalline ceramic material.

19. The method of claim 14, wherein fabrication of the EMR-transmissive assembly is accomplished in the absence of metallization, plating, soldering, brazing and/or welding processes.
